(19) United States
(12) Patent Application Publication
(10) Pub. No.: US 2015/0291851 A1
(43) Pub. Date: Oct. 15, 2015

(54) POLISHING COMPOSITION

(71) Applicant: FUJIMI INCORPORATED, Kiyosu-shi (JP)

(72) Inventors: Hiroshi ASANO, Kiyosu-shi (JP); Maiko ASAI, Kiyosu-shi (JP); Hitoshi MORINAGA, Kiyosu-shi (JP); Kazusei TAMAI, Kiyosu-shi (JP)

(73) Assignee: FUJIMI INCORPORATED, Kiyosu-shi (JP)

(21) Appl. No.: 14/686,285

(22) Filed: Apr. 14, 2015

(30) Foreign Application Priority Data
Apr. 15, 2014 (JP) 2014-083833

(51) Int. Cl. C09G 1/02; B24B 1/00

(52) U.S. Cl. CPC C09G 1/02; B24B 1/00

(57) ABSTRACT

A polishing composition which is able to decrease a difference in polishing rate between the alloy material and the resin, and to polish both the alloy material and the resin at a high polishing rate when polishing a substrate which contains an alloy material and a resin on the surface and has a ratio of the alloy material area to the total polishing area in a specific range is provided. To provide the polishing composition used to polish a substrate which contains an alloy material and a resin on a surface thereof and has a ratio of an alloy material area to a total polishing area of from 60 to 95%, the polishing composition containing crystalline abrasive grains having a cumulative 50% particle size (D₅₀) based on a volume-based particle size distribution of 5.0 μm or more, an acid or a salt thereof and a water-soluble polymer.

### BACKGROUND 1. Technical Field

The present invention relates to a polishing composition.

2. Description of Related Art

An alloy is a mixture obtained by mixing one or more kinds of metal elements or a nonmetallic element such as carbon, nitrogen and silicon with one kind of metal element and is produced for the purpose to improve the properties of the pure metal such as mechanical strength, chemical resistance, corrosion resistance and heat resistance. Among them, the aluminum alloy is used in various applications such as structural materials including building materials and containers, transportation equipment such as motor vehicles, ships and aircrafts as well as various appliances and electronic parts due to its lightweight and excellent strength. In addition, the titanium alloy is widely used in precision instruments, ornaments, tools, sporting goods and medical parts due to its excellent corrosion resistance in addition to its lightweight. Moreover, stainless steel of an iron-based alloy or the nickel alloy is used in various applications such as structural materials and transportation equipment as well as tools, machinery and appliances and cooking utensils due to its excellent corrosion resistance. Further, the copper alloy is widely used in ornaments, utensils, instruments or parts for electric materials since it is excellent in processability in addition to electrical conductivity, thermal conductivity and corrosion resistance and is beautifully finished. Furthermore, a material containing a resin on its surface together with an alloy has been also used in the above-mentioned applications recently.

In the case of using such a material containing an alloy and a resin on the surface, there is a case in which the surface is finished to have a glossy surface. For the glossy surface finish, the mirror finish treatment is performed by subjecting the surface to coating such as painting in some cases, but it is possible to provide a superior glossy surface to the painted surface and the materials and working for coating are not required if the surface can be finished to have a mirror surface by polishing. In addition, the mirror surface by polishing also has an advantage that the glossy surface is maintained for a long period of time since it is highly durable compared to the glossy surface by painting.

Hitherto, the alloy material has been polished using a polishing composition to have a mirror surface or a smooth surface. For example, a polishing composition is disclosed in JP 2008-544868 W (corresponding to WO2007/120163, U.S. Ser. No. 11/173,518) which contains (a) an abrasive material selected from the group consisting of silica, ceria and zirconia, (b) a reagent that oxidizes aluminum and (c) a liquid carrier and is used in an aluminum alloy polishing application.

### SUMMARY OF INVENTION

However, in the case of using the polishing composition described in JP 2008-544868 W (corresponding to WO2007/120163, U.S. Ser. No. 11/173,518) in polishing a substrate containing an alloy material and a resin on the surface, there is a problem that the difference in polishing rate between the alloy material and the resin is great and thus the substrate cannot be uniformly polished. In addition, there is a problem that the smoothness of the surface of substrate after polishing is insufficient and thus a highly glossy surface cannot be obtained.

Accordingly, an object of the invention is to provide a polishing composition which is able to decrease a difference in polishing rate between the alloy material and the resin and to polish both the alloy material and the resin at a high polishing rate when polishing a substrate which contains an alloy material and a resin on the surface and has a ratio of the alloy material area to the total area of the surface of from 60 to 95%, and further able to obtain a substrate having a surface that is excellent in smoothness and highly glossy after polishing.

The present inventors have conducted intensive researches in order to solve the above problems. As a result, it has been found out that the above problems can be solved by the use of a polishing composition containing crystalline abrasive grains having a cumulative 50% particle size (D₅₀) based on a volume-based particle size distribution in a specific range, an acid or a salt thereof and a water-soluble polymer. Hence, the invention has been completed based on the above finding.

In other words, the above problems of the invention can be achieved by means described below:

1. a polishing composition, which is used in polishing a substrate which contains an alloy material and a resin on a surface thereof and has a ratio of an alloy material area to a total polishing area of from 60 to 95%, which comprises crystalline abrasive grains having a cumulative 50% particle size (D₅₀) based on a volume-based particle size distribution of 5.0 μm or more, an acid or a salt thereof, and a water-soluble polymer;

2. The polishing composition according to 1. above-mentioned, wherein the crystalline abrasive grains are at least one kind selected from the group consisting of aluminum oxide, silicon oxide, cerium oxide, zirconium oxide, titanium oxide, manganese oxide, silicon carbide, boron carbide, titanium carbide, titanium nitride, silicon nitride, titanium boride and tungsten boride;

3. The polishing composition according to 1. or 2. above-mentioned, wherein a main component of the alloy material is at least one kind selected from the group consisting of aluminum, titanium, iron, nickel and copper;

4. The polishing composition according to any one of 1. to 3. above-mentioned, wherein the resin is a thermoplastic resin.

5. A polishing method to polish a substrate which contains an alloy material and a resin on a surface thereof and has a ratio of an alloy material area to a total polishing area of from 60 to 95% using the polishing composition according to any one of 1. to 4. above-mentioned;

6. A method for producing a substrate comprising:
a step of polishing a substrate by the polishing method according to 5. above-mentioned.

According to the invention, it is possible to provide a polishing composition which is able to decrease a difference in polishing rate between the alloy material and the resin and to polish both the alloy material and the resin at a high polishing rate when polishing a substrate which contains an alloy material and a resin on the surface and has a ratio of the alloy material area to the total area of the surface of from 60 to 95%, and further able to obtain a substrate having a surface that is excellent in smoothness and highly glossy after polishing.

### DESCRIPTION OF EMBODIMENTS

The invention is a polishing composition which is used in the application to polish a substrate which contains an alloy material and a resin on a surface thereof and has a ratio of an alloy material area to a total polishing area of from 60 to 95% and contains crystalline abrasive grains having a cumulative 50% particle size (D₅₀, hereinafter, also simply referred to as the “D₅₀”) based on a volume-based particle size distribution of 5.0 μm or more, an acid or a salt thereof and a water-soluble polymer. The polishing composition of the invention having such a configuration is able to decrease a difference in polishing rate between the alloy material and the resin, to polish both the alloy material and the resin at a high polishing rate, and further to obtain a substrate having a surface that has improved smoothness and is highly glossy.

The detailed reason for that the above effect is obtained by the polishing composition of the invention is unknown, but the crystalline abrasive grains having the D₅₀ in the range of the invention act to the substrate, provide a high pressure to the substrate and have the abrasive grain number in the range to have adequate acting grain number. By virtue of this, it is possible to increase the mechanical polishing action to the resin on which the chemical polishing action hardly works and to increase the polishing rate of the resin. The water-soluble polymer can further aggregate the crystalline abrasive grains although exhibiting a weak force and thus the aggregated particles of crystalline abrasive grains having a greater particle size can be formed, whereby the polishing rate for the resin can be increased. The acid or a salt thereof contained in the polishing composition of the invention is a polishing accelerator for the alloy material. Hence, the polishing composition of the invention containing crystalline abrasive grains having the D₅₀ in a specific range, an acid or a salt thereof and a water-soluble polymer can polish both the alloy material and the resin at a high polishing rate and further can obtain a substrate having a surface that is excellent in smoothness and highly glossy after polishing.

In addition, in the polishing composition of the invention, the aggregates of the abrasive grains can be easily redispersed.

Incidentally, the mechanism described above is a presumption, and thus the invention is not limited to the mechanism in any way.

### [Polishing Object]

The polishing composition of the invention is used in the application to polish a substrate containing an alloy material and a resin on the surface. The ratio of the area of the alloy material to the total polishing area of the substrate used in the invention (hereinafter, simply referred to as the area ratio of the alloy material) is from 60 to 95%. Incidentally, in the present specification, the area ratio of the alloy material of the polishing object (substrate) adopts the value measured by the following method. In other words, the polishing portion of the polishing object is photographed, and the photographed image is overlaid with a grid of 5 mm square, and the number of grid portion where the alloy material and the resin are present is counted. Moreover, the grid portion where the alloy material is singly present and the grid portion where the resin is singly present are counted, and the grid portion where both the alloy material and the resin are present together is counted for both, and the area ratio of the alloy material is calculated from the numbers.

Hereinafter, the alloy material and the resin contained in the polishing object (substrate) will be described.

### [Alloy Material]

The alloy material contains a metal species to be the main component and a metal species that is different from the main component.

The alloy material is named based on the metal species to be the main component. Examples of the alloy material may include an aluminum alloy, a titanium alloy, stainless steel (containing iron as the main component), a nickel alloy and a copper alloy.

The aluminum alloy contains aluminum as the main component and, for example, at least one kind selected from the group consisting of silicon, iron, copper, manganese, magnesium, zinc and chromium as a metal species that is different from the main component. The content of the metal species that is different from the main component in the aluminum alloy is, for example, from 0.1 to 10% by mass with respect to the total alloy material. Examples of the aluminum alloy may include the alloy numbers 1085, 1080, 1070, 1050, 1050A, 1060, 1100, 1200, 1N00, 1N30, 2014, 2014A, 2017, 2017A, 2219, 2024, 3003, 3103, 3203, 3004, 3104, 3005, 3105, 5005, 5021, 5042, 5052, 5652, 5154, 5254, 5454, 5754, 5082, 5182, 5083, 5086, 5N01, 6101, 6061, 6082, 7010, 7075, 7475, 7178, 7N01, 8021, 8079 described in JIS H4000: 2006; the alloy numbers 1070, 1060, 1050, 1050A, 1100, 1200, 2011, 2014, 2014A, 2017, 2017A, 2117, 2024, 2030, 2219, 3003, 3103, 5N02, 5050, 5052, 5454, 5754, 5154, 5086, 5056, 5083, 6101, 6N01, 6005A, 6060, 6061, 6262, 6063, 6082, 6181, 7020, 7N01, 7003, 7050, 7075, 7049A described in JIS H4040: 2006; and the alloy numbers 1070A1070S, 1060A1060S, 1050A1050S, 1100A1100S, 1200Al200S, 2014A2014S, 2014A2014AS, 2017A2017S, 2017A2017AS, 2024A2024S, 3003A3003S, 3203A3203S, 5052A5052S, 5454A5454S, 5083A5083S, 5086A5086S, 6101A6101S, 6NO1A6NO1S, 6005AA6005AS, 6060A6060S, 6061A6061S, 6063A6063S, 6082A6082S, 7N01A7N01S, 7003A7003S, 7005A7005S, 7020A7020S, 7050A7050S, 7075A7075S described in JIS H4100: 2006.

The titanium alloy contains titanium as the main component and, for example, aluminum, iron, and vanadium as a metal species that is different from the main component.

The content of the metal species that is different from the main component in the titanium alloy is, for example, from 3.5 to 30% by mass with respect to the total alloy material . Examples of the titanium alloy may include Classes 11 to 23, Class 50, Class 60, Class 61 and Class 80 in the classification described in JIS H4600: 2012.

Stainless steel contains iron as the main component and, for example, at least one kind selected from the group consisting of chromium, nickel, molybdenum and manganese as a metal species that is different from the main component. The content of the metal species that is different from the main component in stainless steel is, for example, from 10 to 50% by mass with respect to the total alloy material. Examples of stainless steel may include the Class numbers SUS201, 303, 303Se, 304, 304L, 304N1, 305, 305J1, 309S, 310S, 316, 316L, 321, 347, 384, XM7, 303F, 303C, 430, 430F, 434, 410, 416, 420J1, 420J2, 420F, 420C, 631J1 described in JIS G4303: 2005.

The nickel alloy contains nickel as the main component and, for example, at least one kind selected from the group consisting of iron, chromium, molybdenum and cobalt as a metal species that is different from the main component. The content of the metal species that is different from the main component in the nickel alloy is, for example, from 20 to 75% by mass with respect to the total alloy material. Examples of the nickel alloy may include the alloy numbers NCF600, 601, 625, 750, 800, 800H, 825, NW0276, 4400, 6002, 6022 described in JIS H4551: 2000.

The copper alloy contains copper as the main component and, for example, at least one kind selected from the group consisting of iron, lead, zinc and tin as a metal species that is different from the main component. The content of the metal species that is different from the main component in the copper alloy is, for example, from 3 to 50% by mass with respect to the total alloy material. Examples of the copper alloy may include the alloy numbers C2100, 2200, 2300, 2400, 2600, 2680, 2720, 2801, 3560, 3561, 3710, 3713, 4250, 4430, 4621, 4640, 6140, 6161, 6280, 6301, 7060, 7150, 1401, 2051, 6711, 6712 described in JIS H3100: 2006.

The main component of the alloy material is preferably at least one kind selected from the group consisting of aluminum, titanium, iron, nickel and copper. As the alloy material, an aluminum alloy, stainless steel or a titanium alloy is more preferable.

### [Resin]

The kind of the resin is not particularly limited and may be either of a thermosetting resin or a thermoplastic resin.

Examples of the thermosetting resin may include an epoxy resin, a polyimide resin, a phenolic resin, an amino resin and an unsaturated polyester resin.

Examples of the thermoplastic resin may include a polystyrene resin, an acrylonitrile-butadiene-styrene copolymer resin (ABS resin), a (meth)acrylic resin, an organic acid vinyl ester resin or a derivative thereof, a vinyl ether resin, a halogen-containing resin such as polyvinyl chloride, polyvinylidene chloride and polyvinylidene fluoride, an olefin resin such as polyethylene and polypropylene, a polycarbonate resin, a saturated polyester resin such as polyethylene terephthalate and polyethylene naphthalate, a polyamide resin, a thermoplastic polyurethane resin, a polysulfone resin (polyethersulfone, polysulfone and the like), a polyphenylene ether resin (polymer of 2,6-xylenol, and the like), a cellulose derivative (cellulose esters, cellulose carbamates, cellulose ethers and the like), a silicone resin (polydimethylsiloxane, polymethylphenylsiloxane and the like).

The resins described above can be used singly or in combination of two or more kinds. Among these resins, a thermoplastic resin is preferable and a polycarbonate resin, an acrylic resin and an ABS resin are more preferable from the viewpoint of impact resistance and weather resistance.

Next, the configuration of the polishing composition of the invention will be described in detail.

### [Crystalline Abrasive Grains]

The polishing composition of the invention contains crystalline abrasive grains having a cumulative 50% particle size (D₅₀) based on a volume-based particle size distribution of 5.0 μm or more. It is possible to improve the polishing rate of the resin and to decrease the difference in polishing rate between the alloy material and the resin by the use of such crystalline abrasive grains. Here, in the present specification, the “crystalline abrasive grains” means the abrasive grains which have a peak derived from crystal in the diffraction pattern when subjected to the powder X-ray diffraction measurement using an X-ray diffraction apparatus.

Specific examples of such crystalline abrasive grains may preferably include at least one kind selected from the group consisting of aluminum oxide (alumina), silicon oxide (silica), cerium oxide (ceria), zirconium oxide, titanium oxide, manganese oxide, silicon carbide, boron carbide, titanium carbide, titanium nitride, silicon nitride, titanium boride and tungsten boride. Among these, aluminum oxide (alumina), silicon oxide (silica) and zirconium oxide are preferable from the viewpoint of hardness and cost.

Examples of the kind of alumina may include α-alumina, intermediate alumina (γ-alumina, δ-alumina and θ-alumina) and fumed alumina, and it is possible to suitably use any of them.

The cumulative 50% particle size (D₅₀) based on a volume-based particle size distribution is 5.0 μm or more. The polishing rate for the resin decreases when the D₅₀ of the crystalline abrasive grains is less than 5.0 The D₅₀ of the crystalline abrasive grains is preferably 7.0 μm or more. In addition, the upper limit value of the D₅₀ is not particularly limited but is preferably 30 μm or less.

Incidentally, in the present specification, the D₅₀ of the crystalline abrasive grains can be measured using a commercially available particle size measuring device. As the particle size measuring device, it is possible to use those which are based on any technique of a dynamic light scattering method, a laser diffraction method, a laser scattering method and a pore electric resistance method.

The lower limit value of the content of the crystalline abrasive grains in the polishing composition is preferably 0.1% by mass or more, more preferably 0.2% by mass or more and even more preferably 1% by mass or more. The polishing rate increases as the content of the crystalline abrasive grains increases.

In addition, the upper limit value of the content of the crystalline abrasive grains in the polishing composition is preferably 50% by mass or less, more preferably 25% by mass or less and even more preferably 20% by mass or less. It is easy to obtain a surface having fewer defects such as scratches by polishing using the polishing composition in addition to that the production cost of the polishing composition decreases as the content of the crystalline abrasive grains decreases.

### [Acid or Salt Thereof]

The polishing composition of the invention contains an acid or a salt thereof . The acid or a salt thereof serves a function as a polishing accelerator of the alloy material and further improves the polishing rate of the alloy material

As the acid, it is possible to use either of an inorganic or an organic acid. Examples of the inorganic acid may include hydrochloric acid, sulfuric acid, nitric acid, hydrofluoric acid, boric acid, carbonic acid, hypophosphorous acid, phosphorous acid and phosphoric acid. Examples of the organic acid may include formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, diglycolic acid, 2-furancarboxylic acid, 2,5-furandicarboxylic acid, 3-furancarboxylic acid, 2-tetrahydrofurancarboxylic acid, methoxyacetic acid, methoxyphenylacetic acid and phenoxyacetic acid. Furthermore, examples of the salts thereof may include a Group 1 element salt thereof, a Group 2 element salt thereof, an aluminum salt thereof, an ammonium salt thereof, an amine salt thereof and a quaternary ammonium salt thereof . These acids or the salts thereof can be used singly or as a mixture of two or more kinds.

Among these, phosphoric acid, nitric acid and citric acid are preferable.

The lower limit value of the content of the acid or a salt thereof in the polishing composition is preferably 0.01% by mass or more, more preferably 0.02% by mass or more and even more preferably 0.1% by mass or more. The polishing rate increases as the content of the acid or a salt thereof increases.

In addition, the upper limit value of the content of the acid or a salt thereof in the polishing composition is preferably 5% by mass or less, more preferably 3% by mass or less and even more preferably 2% by mass or less. The polishing rate of the polishing object by the polishing composition is more suitably improved in a case in which the content of the acid or a salt thereof is adequate.

### [Water-Soluble Polymer]

The polishing composition of the invention contains a water-soluble polymer. The water-soluble polymer can aggregate the crystalline abrasive grains although exhibiting a weak force and thus can further improve the polishing rate of the resin. In addition, the water-soluble polymer can serve a function to redisperse the aggregates of the abrasive grains.

Examples of the water-soluble polymers may include a polycarboxylic acid such as polyacrylic acid, a polysulfonic acid such as polyphosphonic acid and polystyrene sulfonic acid, polysaccharides such as xanthan gum and sodium alginate, a cellulose derivative such as hydroxyethyl cellulose and carboxymethyl cellulose, polyethylene glycol, polyvinyl alcohol, polyvinyl pyrrolidone, a polyoxyethylene alkyl ether, a polyoxyethylene alkylphenyl ether, sorbitan monooleate, an oxyalkylen-based polymer having one kind or plural kinds of oxyalkylene units. In addition, it is also possible to suitably use a salt of the compounds described above as the water-soluble polymer. These water-soluble polymers can be used singly or as a mixture of two or more kinds.

Among these, the polycarboxylic acid or a salt thereof, the polyphosphonic acid or a salt thereof, and the polysulfonic acid or a salt thereof are preferable, and sodium polyacrylate and polysulfonic acid are more preferable.

The lower limit value of the weight average molecular weight of the water-soluble polymer is preferably 1,000 or more. On the other hand, the upper limit value of the weight average molecular weight of the water-soluble polymer is preferably 1,000,000 or less. Incidentally, the weight average molecular weight of the water-soluble polymer can be measured by gel permeation chromatography (GPC).

The lower limit value of the content of the water-soluble polymer in the polishing composition is preferably 0.01% by mass or more. It is possible to enhance the redispersibility as the content of the water-soluble polymer increases.

In addition, the upper limit value of the content of the water-soluble polymer in the polishing composition is preferably 10% by mass or less. The polishing rate increases as the content of the water-soluble polymer decreases.

### [pH of Polishing Composition]

The lower limit value of the pH of the polishing composition of the invention is preferably 1 or more and more preferably 1.5 or more.

In addition, the upper limit value of the pH of the polishing composition of the invention is preferably 7 or less, more preferably 6 or less and even more preferably 4.5 or less.

The pH can be controlled by the acid or a salt thereof which is a component of the polishing composition of the invention, but it is also possible to control the pH using a known acid, a known base or a salt thereof other than the acid or a salt thereof described above.

### [Other Components]

The polishing composition of the invention may further contain other components such as water, an etching agent that promotes the dissolution of the alloy material, an oxidant that oxidizes the surface of the alloy material, a corrosion inhibitor that inhibits the corrosion of the surface of the alloy material or a chelating agent, a dispersing auxiliary that facilitates the redispersion of the aggregates of abrasive grains, and a preservative and an antifungal agent that have other functions if necessary.

### [Water]

The polishing composition of the invention preferably contains water as a dispersion medium or solvent for dispersing or dissolving each component. Water containing impurities as little as possible is preferable from the viewpoint of suppressing the inhibition of the impurities on the action of other components, and specifically, pure water, ultrapure water or distilled water from which the impurity ions are removed by an ion exchange resin and then the foreign matters are removed through a filter is preferable.

### [Other Components Other Than Water]

Examples of the etching agent may include an inorganic acid such as nitric acid, sulfuric acid and phosphoric acid, an organic acid such as acetic acid, citric acid, tartaric acid or methanesulfonic acid, an inorganic alkali such as potassium hydroxide and sodium hydroxide, an organic alkali such as ammonia, amine, quaternary ammonium hydroxide. Examples of the oxidant may include hydrogen peroxide, peracetic acid, a percarbonate salt, urea peroxide, a perchlorate salt and a persulfate salt. Examples of the corrosion inhibitor may include amines, pyridines, a tetraphenylphosphonium salt, benzotriazoles, triazoles, tetrazoles and benzoic acid. Examples of chelating agent may include a carboxylic acid-based chelating agent such as gluconic acid, an amine-based chelating agent such as ethylene diamine, diethylene triamine and trimethyl tetramine, a polyamino polycarboxylic acid-based chelating agent such as ethylenediaminetetraacetic acid, nitrilotriacetic acid, hydroxyethylethylenediaminetriacetic acid, triethylenetetraminehexaacetic acid and diethylenetriaminepentaacetic acid, an organic phosphonic acid-based chelating agent such as 2-aminoethylphosphonic acid, 1-hydroxyethylidene-1,1-diphosphonic acid, amino tri(methylenephosphonic acid), ethylenediamine tetrakis(methylenephosphonic acid), diethylenetriamine penta(methylenephosphonic acid), ethane-1,1-diphosphonic acid, ethane-1,1,2-triphosphonic acid, methanehydroxyphosphonic acid and 1-phosphonobutane-2,3,4-tricarboxylic acid, a phenol derivative and a 1,3-diketone. Examples of the dispersing auxiliary may include a condensed phosphate salt such as a pyrophosphate salt or a hexametaphosphate salt. Examples of the preservative may include sodium hypochlorite. Examples of the antifungal agent may include an oxazoline such as oxazolidine-2,5-dione.

### [Method for Producing Polishing Composition]

The method for producing a polishing composition of the invention is not particularly limited, and for example, the polishing composition can be obtained by mixing crystalline abrasive grains, an acid or a salt thereof, a water-soluble polymer and other components if necessary in water through stirring.

The temperature at the time of mixing the respective components is not particularly limited but is preferably from 10 to 40° C., and the mixture may be heated in order to increase the dissolution rate. In addition, the mixing time is also not particularly limited.

### [Polishing Method and Method for Producing Alloy Material]

As described above, the polishing composition of the invention is suitably used in polishing a substrate which contains an alloy material and a resin on the surface. Hence, the invention provides a polishing method to polish a substrate which contains an alloy material and a resin on the surface and has a ratio of the alloy material area to the total polishing area of from 60 to 95% using the polishing composition of the invention. In addition, the invention provides a method for producing a substrate including a step of polishing a substrate which contains an alloy material and a resin on the surface and has a ratio of the alloy material area to the total polishing area of from 60 to 95% by the above polishing method.

It is possible to conduct the polishing using a polishing apparatus and the polishing condition which are used in usual metal polishing when polishing a substrate using the polishing composition of the invention. There are a single sided polishing apparatus and a double sided polishing apparatus as the general polishing apparatus. In the case of a single sided polishing apparatus, the substrate is held using a holder called carrier, the polishing table on which the polishing cloth is pasted is pressed against one side of the substrate and rotated while supplying the polishing composition, thereby polishing one side of the substrate. In the case of a double sided polishing apparatus, the substrate is held using a holder called carrier, the polishing table on which the polishing cloth is pasted is pressed against the facing surface of the substrate and they are rotated in the relative direction while supplying the polishing composition from above, thereby polishing both sides of the substrate. At this time, the polishing is conducted by the physical action due to the friction among the polishing pad, the polishing composition and the substrate and the chemical action proceeding between the alloy and the polishing composition.

As the polishing condition in the polishing method according to the invention, the polishing load is mentioned. In general, the frictional force by the crystalline abrasive grains increases as the polishing load increases, thus the mechanical working force is improved, and the polishing rate increases as a result. The load in the polishing method according to the invention is not particularly limited but is preferably from 50 to 1,000 g/cm², more preferably from 80 to 800 g/cm² and even more preferably from 100 to 600 g/cm² per unit area of the substrate. In this range, it is possible to exert a sufficient polishing rate and to suppress the damage of substrate by the load and the generation of a defect such as scratches on the surface.

In addition, as the polishing condition in the polishing method according to the invention, the linear velocity in polishing is mentioned. In general, the linear velocity is affected by the rotation number of polishing pad, the rotation number of carrier, the size of substrate and the number of substrates, but the frictional force applied to the substrate is great when the linear velocity is great, and thus the action to mechanically polish the edge increases .

In addition, there is a case in which frictional heat is generated by friction and thus the chemical action by the polishing composition is enhanced. The linear velocity in the polishing method according to the invention is not particularly limited but is preferably from 10 to 300 m/min and more preferably 30 to 200 m/min. In this range, it is possible to obtain a sufficient polishing rate, to suppress the damage of the polishing pad by the friction of substrate, to sufficiently transmit the friction to the substrate, to prevent the substrate from being in the so-called slipping state, and thus to sufficiently polish the substrate.

Examples of the polishing pad used in the polishing method using the polishing composition of the above embodiment may include a polyurethane type, a polyurethane foam type, a nonwoven fabric type and a suede type which are different in the property of material, those which are different in physical properties such as hardness and thickness, and those which contain abrasive grains and those which do not contain abrasive grains, and it is preferable to use the polyurethane foam type or the suede type among them. In addition, in the case of using the suede type, those which are less deformed by the pressure during the processing, that is, the pads which exhibit a high hardness are more preferable. Specifically, the pads which exhibit a hardness of 75 or more measured by TECLOCK are favorable, and for example, it is possible to obtain a suede type pad which exhibits a high hardness by using polyethylene terephthalate or a nonwoven fabric for the substrate. For TECLOCK, the measuring method is regulated by JIS K6253: 1997.

As the polishing condition in the polishing method according to the invention, the supply amount of the polishing composition is mentioned. The supply amount varies depending on the kind of the substrate to be polished, the polishing apparatus or the polishing conditions but may be the amount which is enough for the polishing composition to be evenly supplied to the entire surface between the substrate and the polishing pad. There is a case in which the polishing composition is not supplied to the entire substrate or the composition dries and coagulates to cause a defect on the surface of substrate when the supply amount of the polishing composition is small. On the contrary, friction is interfered by the excess polishing composition, particularly the medium such as water and thus polishing is inhibited in addition to that it is not economical when the supply amount is great.

The polishing method according to the invention can have a preliminary polishing step using another polishing composition before the polishing step. In a case in which the alloy surface has the processing damage or scratches generated at the time of transportation, it takes a long time to change those scratches to a mirror surface by one step, it is uneconomical and also there is a risk that the smoothness is impaired. It is possible to shorten the polishing time required for the polishing by the polishing method of the invention and to expect to obtain an excellent mirror surface efficiently by removing the scratches on the alloy surface through the preliminary polishing step. Hereinafter, the preliminary polishing composition used in the preliminary polishing step will be described.

As the preliminary polishing composition used in the preliminary polishing step, it is preferable to use those having a stronger abrasive force compared to the polishing composition used in the invention. Specifically, it is preferable to use abrasive grains which have a higher hardness and greater particle size than the crystalline abrasive grains used in the polishing composition used in the present embodiment.

Examples of the abrasive grains contained in the preliminary polishing composition may include silicon carbide, aluminum oxide (alumina), zirconia, zircon, ceria and titania, but the abrasive grains are not limited thereto. Among these abrasive grains, it is particularly preferable to use aluminum oxide. As aluminum oxide, the kind thereof is not particularly limited, and for example, it is possible to use α-alumina, δ-alumina, θ-alumina, κ-alumina and other morphologically different ones. In addition, aluminum oxide may contain an impurity element such as silicon, titanium, iron, copper, chromium, sodium, potassium, calcium and magnesium other than aluminum.

Incidentally, in a case in which the alloy material contained in the substrate is a hard and brittle material and the alloy material is polished at a higher rate, it is preferable to use alumina containing α-alumina as the main component and those in which the transformation rate to α-alumina in the crystalline form of alumina constituting the alumina abrasive grains is 20% or more and further 40% or more. The transformation rate to α-alumina referred to here is one determined from the integral intensity ratio of the (113) plane diffraction line by the X-ray diffraction measurement.

The average particle size of the abrasive grains contained in the preliminary polishing composition is 0.1 μm or more and more preferably 0.3 μm or more. The polishing rate of the substrate is improved as the average particle size of the abrasive grains increases.

The average particle size of the abrasive grains contained in the preliminary polishing composition is preferably 20 μm or less. It is easy to obtain a surface having fewer defects and a lower roughness as the average particle size of the abrasive grains decreases. Incidentally, the measurement of the average particle size of the abrasive grains can be performed, for example, using a laser diffraction/scattering type particle size distribution measuring apparatus such as the “LA-950” manufactured by HORIBA, Ltd.

The content of the abrasive grains in the preliminary polishing composition is preferably 0.5% by mass or more and more preferably 1% by mass or more. The polishing rate of the substrate by the polishing composition is improved as the content of the abrasive grains increases.

The content of the abrasive grains in the preliminary polishing composition is preferably 20% by mass or less and more preferably 10% by mass or less. It is easy to obtain a surface having fewer scratches by polishing using the polishing composition in addition to that the production cost of the polishing composition decreases as the content of the abrasive grains decreases.

The pH of the preliminary polishing composition may vary depending on the kind of the substrate to be polished. The pH in the preliminary polishing composition is adjusted by a known acid, a known base or a salt thereof. It is possible to expect an improvement in the polishing rate by the action to the surface of the abrasive grains or the like in the case of using an organic acid, particularly glycolic acid, succinic acid, maleic acid, citric acid, tartaric acid, malic acid, gluconic acid, oxalic acid and itaconic acid as the acid among them.

It is possible to collect the polishing composition which is once used for polishing and to use it again in polishing when polishing the substrate using the polishing composition of the invention. As an example of the method to reuse the polishing composition, a method is mentioned in which the polishing composition discharged from the polishing apparatus is collected in a tank and then circulated again to the polishing apparatus to be used. The cyclic use of the polishing composition is useful in terms that the environmental burden can be diminished since the amount of polishing composition to be discharged as the effluent decreases and the production cost for polishing the substrate can be cut down since the amount of the polishing composition to be used decreases.

At the time of the cyclic use of the polishing composition of the invention, a part or all of the crystalline abrasive grains, the acid or a salt thereof, the water-soluble polymer and other additives which have been consumed and lost by polishing can be added as the composition adjusting agent during the cyclic use. In this case, a part or all of the crystalline abrasive grains, the acid or a salt thereof, the water-soluble polymer and other additives may be mixed together in an arbitrary mixing ratio as the composition adjusting agent. The polishing composition is adjusted to a composition suitable to be reused and polishing is suitably maintained by additionally adding the composition adjusting agent. The concentrations of the crystalline abrasive grains, the acid or a salt thereof, the water-soluble polymer and other additives contained in the composition adjusting agent are arbitrary and are not particularly limited, but it is preferable that the concentrations be appropriately adjusted depending on the size of the circulation tank and the polishing conditions.

The polishing composition of the invention may be a one-component type or a multi-component type including a two-component type. In addition, the polishing composition of the invention may be prepared by diluting a stock solution of the polishing composition, for example, by 10 times or more using a diluent such as water.

### EXAMPLES

The invention will be described in more detail with reference to the following an Example and Comparative Examples. However, the technical scope of the invention is not limited to only the following Example.

### Example 1 and Comparative Examples 1 to 4

The particles presented in the following Table 2 as the crystalline abrasive grains were diluted with water so as to have a content of 13% by mass and citric acid as the acid or a salt thereof and sodium polyacrylate (weight average molecular weight: 2,000) as the water-soluble polymer were added thereto and stirred so as to have a content of 0.5% by mass and a content of 0.5% by mass, respectively, whereby the polishing composition was prepared. The pH of the polishing composition confirmed by a pH meter was 3.3.

In Example 1 and Comparative Examples 1 to 3, α-alumina was used.

Incidentally, the D₅₅ of alumina was measured using a laser diffraction/scattering type particle size distribution measuring apparatus, LA-950 (manufactured by HORIBA, Ltd.). The D₅₀ of the colloidal silica was measured using a particle size measuring instrument (UPA-UT151 manufactured by NIKKISO CO., LTD.) by a dynamic light scattering method. The specific surface areas of alumina and colloidal silica were measured by Flow SorbII 2300 manufactured by Shimadzu Corporation.

The polishing step of simultaneously polishing two pieces of substrate formed of an aluminum alloy and one piece of substrate formed of a polycarbonate (PC) resin which had the same size as one another was conducted using the polishing composition of each of the Example and the Comparative Examples. In other words, the present experiment is an experiment corresponding to the polishing of the substrate having the area ratio of the alloy material of 66.7%. Incidentally, the substrate formed of the alloy number 5052 (A5052) described in JIS H4000: 2006 was used as the substrate formed of an aluminum alloy. The polishing condition in the polishing step is presented in the following Table 1.

In addition, the polishing rate and the surface roughness of the polished surface after the polishing step were evaluated by the methods to be described below.

### <Polishing Rate>

The mass of the substrate before the polishing step and the mass of the substrate after the polishing step were measured for the two kinds of the substrate formed of an aluminum alloy and the substrate formed of a polycarbonate resin, and the polishing rate was calculated from the difference in mass before and after the polishing step. The results are presented in the column of “polishing rate” in the following Table 2. Incidentally, the “difference in rate” in Table 2 represents the absolute value of the difference obtained by subtracting the polishing rate of the polycarbonate from that of the alloy.

### <Surface Roughness>

The “Ra” indicating the surface roughness of the polished surface was measured for each of the substrate formed of an alloy and the substrate formed of polycarbonate after the polishing step using a non-contact surface shape measuring instrument (laser microscope VK-X200 manufactured by KEYENCE CORPORATION) based on the method described in JIS B0601: 2001. Incidentally, the “Ra” is a parameter indicating the average amplitude in the height direction of the roughness curve and represents the arithmetic average of the height of the substrate surface within a certain field of vision. As the measurement condition of the non-contact surface shape measuring instrument, the measurement range was set to 284 μm×213 μm. The results are presented in the column of “Ra” in the following Table 2.

TABLE 1

| | |
|---|---|
| Polishing machine | Single sided polishing machine |
| | (diameter of polishing table: 380 nm) |
| Polishing pad | Polyurethane foam type |
| Polishing load | 175 g/cm² |
| Rotation number of | 90 rpm |
| polishing table | |
| Linear velocity | 72 m/min |
| Polishing time | For 10 minutes |
| Temperature of | 20° C. |
| polishing composition | |
| Supply rate of | 14 ml/min |
| polishing composition | |
| Substrate | Alloy number A5052: 2 pieces with size |
| | of 32 mm × 32 mm × 5 mm |
| | Polycarbonate: 1 piece with size of |
| | 32 mm × 32 mm × 5 mm |
| | Polished 3 pieces at the same time |

TABLE 2

| | | | Polishing | | | | |
|---|---|---|---|---|---|---|---|
| | Abrasive grains | | rate | | Difference | | |
| | | D₅₀ | (μm/min) | | in rate | Ra (nm) | |
| | Kind | (μm) | Alloy | PC | (μm/min) | Alloy | PC |
| Example 1 | Alumina | 7.5 | 2.6 | 2.7 | 0.1 | 106 | 103 |
| Comparative | Alumina | 0.6 | 3.3 | 2.3 | 1.0 | 43 | 28 |
| Example 1 | | | | | | | |
| Comparative | Alumina | 0.8 | 3.1 | 1.4 | 1.7 | 34 | 21 |
| Example 2 | | | | | | | |
| Comparative | Alumina | 3.0 | 3.0 | 1.7 | 1.3 | 51 | 38 |
| Example 3 | | | | | | | |
| Comparative | Colloidal | 0.1 | 0.1 | 0.0 | 0.1 | 15 | 12 |
| Example 4 | silica | | | | | | |

As presented in Table 2, it has been found that the difference in polishing rate between the alloy material and the resin (PC) is small and it is possible to polish both the alloy material and the resin at a high polishing rate in the case of using the polishing composition of Example 1. In addition, from the results of the surface roughness (Ra), it has been found that a substrate having a surface that is excellent in smoothness and highly glossy is obtained.

In the case of the polishing compositions of Comparative Examples 1 to 3 in which the value of D₅₀ is out of the range of the invention, the difference in polishing rate between the alloy material and the resin (PC) is great. In addition, it is almost impossible to polish the resin (PC) in the case of the polishing composition of Comparative Example 4 in which colloidal silica is used as the abrasive grains.

In addition, the entire disclosure of Japanese Patent Application No.2014-083833 filed on Apr. 15, 2014 including specification, claims, drawings and summary are incorporated herein by reference in its entirety.

1. A polishing composition for use in polishing a substrate which contains an alloy material and a resin on a surface thereof and has a ratio of an alloy material area to a total polishing area of from 60 to 95%, which comprises:
crystalline abrasive grains having a cumulative 50% particle size (D₅₀) based on a volume-based particle size distribution of 5.0 μm or more;
an acid or a salt thereof; and
a water-soluble polymer.

2. The polishing composition according to claim 1, wherein the crystalline abrasive grains are at least one kind selected from the group consisting of aluminum oxide, silicon oxide, cerium oxide, zirconium oxide, titanium oxide, manganese oxide, silicon carbide, boron carbide, titanium carbide, titanium nitride, silicon nitride, titanium boride and tungsten boride.

3. The polishing composition according to claim 1, wherein a main component of the alloy material is at least one kind selected from the group consisting of aluminum, titanium, iron, nickel and copper.

4. The polishing composition according to claim 1, wherein the resin is a thermoplastic resin.

5. A polishing method to polish a substrate which contains an alloy material and a resin on a surface thereof and has a ratio of an alloy material area to a total polishing area of from 60 to 95% using the polishing composition according to claim 1.

6. A method for producing a substrate comprising:
a step of polishing a substrate by the polishing method according to claim 5.
